(19) United States
(12) Patent Application Publication
(10) Pub. No.: US 2011/0187866 A1
(43) Pub. Date: Aug. 4, 2011

(54) CAMERA ADJUSTING SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/786,289

(22) Filed: May 24, 2010

(30) Foreign Application Priority Data
Feb. 2, 2010 (TW) 99102938

(51) Int. Cl. H04N 7/18

(52) U.S. Cl. 348/159; 348/E07.085

(57) ABSTRACT

A camera adjusting system includes a first camera, a second camera, and a control apparatus. The first camera is movably arranged on a sliding rail to monitor a locale. The second camera captures an image of a head of a subject. The control apparatus receives the captured image of the head of the subject and compares the captured image with a reference image, to compute a compared result, and outputs a control signal to the first camera to adjust parameters of the first camera according to the compared result.

### CROSS-REFERENCE

Relevant subject matters are disclosed in three co-pending U.S. patent applications (Attorney Docket No. US30264, US30265, US31916) filed on the same date and having the same title, which are assigned to the same assignee as this patent application.

### BACKGROUND

1. Technical Field

The present disclosure relates to a camera adjusting system and a camera adjusting method.

2. Description of Related Art

Pan-tilt-zoom (PTZ) cameras are commonly used in security systems and, generally, are remotely controlled through the use of computers. To aim the camera and/or adjust the focus may require complex commands to be entered with a keyboard of the computer controlling the camera. This may also be slow and inconvenient. Therefore, there is room for improvement in the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic view of an embodiment of a camera adjusting system including a first camera.

FIG. 2 is a block diagram of the control apparatus of FIG. 1.

FIG. 3 is a schematic view of a head of a subject.

FIGS. 3A and 3B are schematic views of the head of the subject of FIG. 3 tilted right and left, respectively.

FIGS. 4A and 4B are schematic views of the side of the head of the subject of FIG. 3 turned right and left, respectively.

FIGS. 5A and 5B are schematic views of the head of the subject of FIG. 3 raised and lowered, respectively.

FIGS. 6A-6C are three schematic views of the first camera of FIG. 1 in three different positions, respectively, together with corresponding captured images and the corresponding postures of the head of the subject.

FIG. 7 is a flowchart of an embodiment of a camera adjusting method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

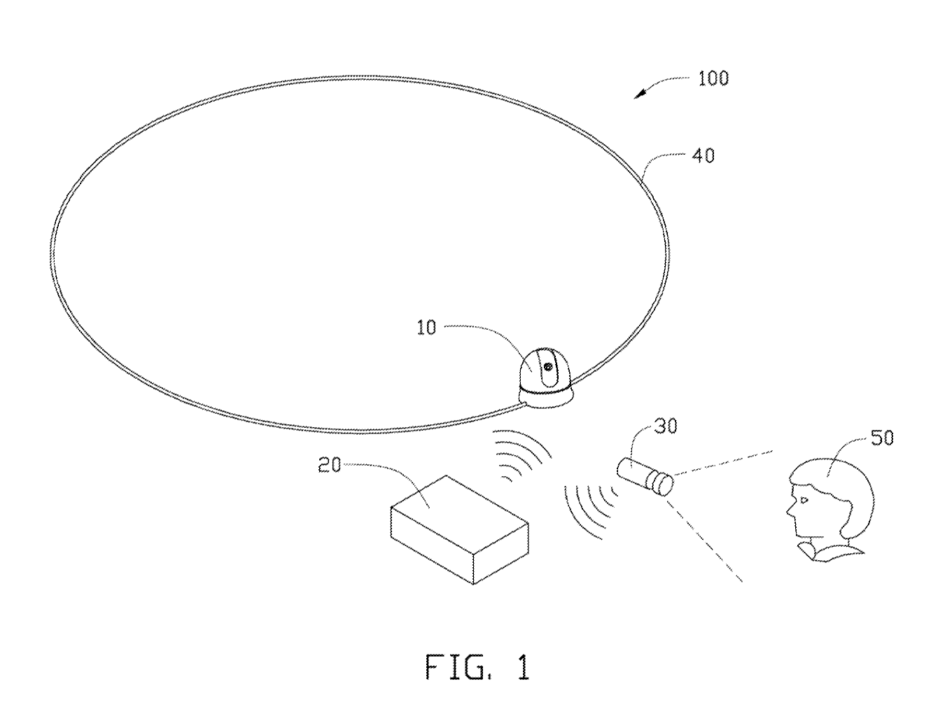

Referring to FIG. 1, an embodiment of a camera adjusting system 100 includes a first camera 10, a control apparatus 20, a second camera 30, and a sliding rail 40. In one embodiment, the sliding rail 40 is circular. In other embodiments, the sliding rail 40 can be designed to be other shapes according to requirements.

The first camera 10 is used to monitor a locale such as a house. The second camera 30 is used to capture an image of a head of a subject 50, and send the captured image to the control apparatus 20. The control apparatus 20 receives the captured image and compares the captured image with a reference image, and adjusts the parameters, such as the capturing angles, the positions on the sliding rail 40, and the zoom scales, of the first camera 10, according to a compared result between the captured image and the reference image. The first camera 10 is controlled by the control apparatus 20 to move on the sliding rail 40.

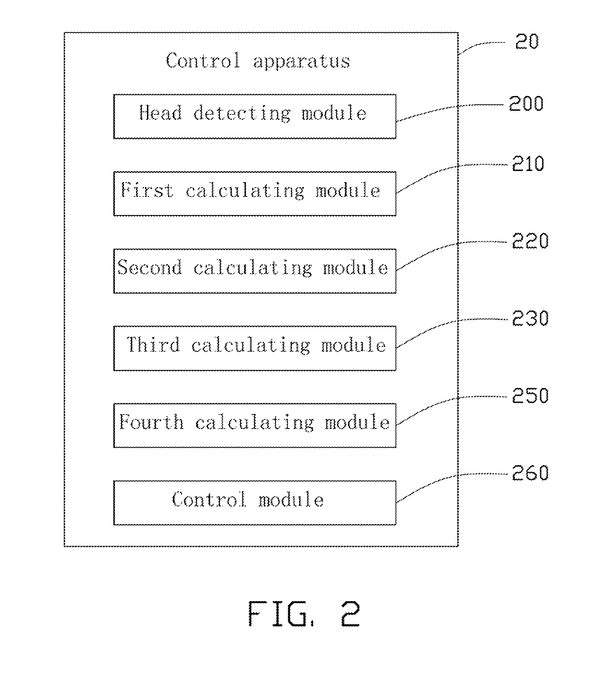

Referring to FIG. 2, the control apparatus 20 includes a head detecting module 200, a first calculating module 210, a second calculating module 220, a third calculating module 230, a fourth calculating module 250, and a control module 260.

The head detecting module 200 is used to receive the captured image of the head of the subject 50 from the second camera 30. In one embodiment, the head detecting module 200 may use the AdaBoost algorithm to detect the captured image.

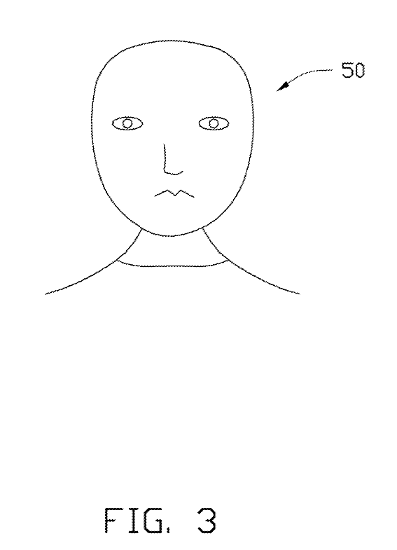

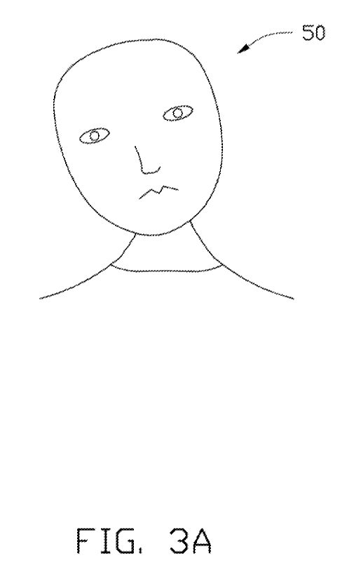

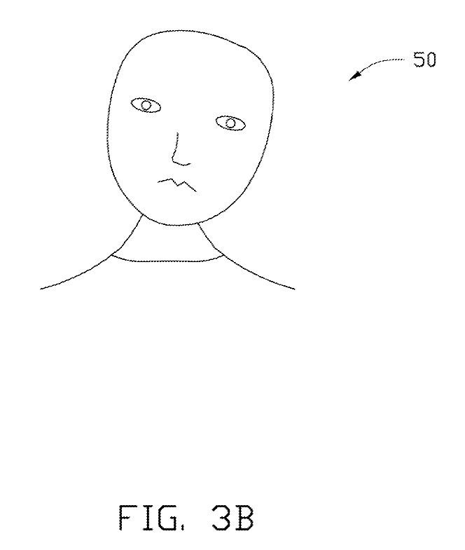

The first calculating module 210 is used to calculate the captured image to compute a tilted angle of the head of the subject 50. In one embodiment, the first calculating module 210 compares a reference image with the actual captured image, to compute the tilted angle of the head of the subject 50. FIG. 3 shows the reference image of the head of the subject 50, which is straight. FIGS. 3A and 3B show two different tilted angles of the head of the subject 50, one is tilted right and the other is tilted left.

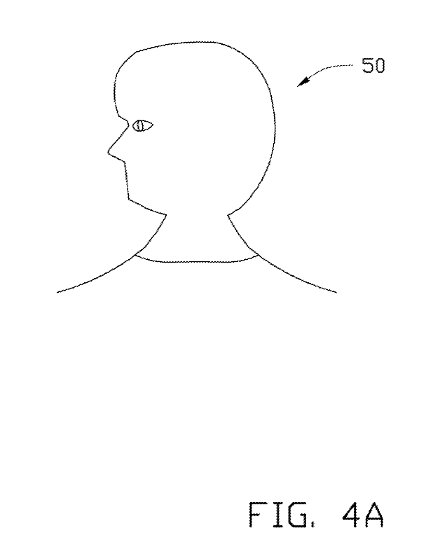

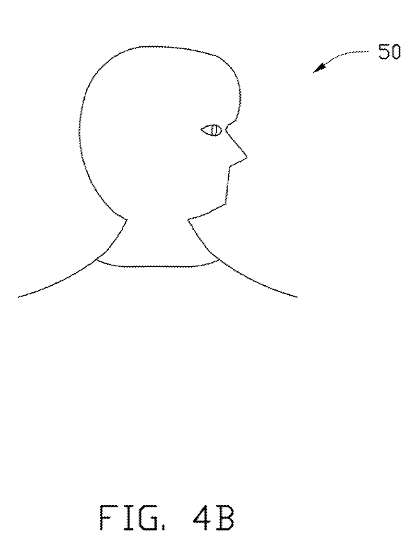

The second calculating module 220 is used to calculate the captured image to compute a turned angle of the head of the subject 50. In one embodiment, the second calculating module 220 compares the reference image of FIG. 3 with the actual captured image, to compute the turned angle of the head of the subject 50. FIGS. 4A and 4B show two different turned angles of the head of the subject 50, one is turned right and the other is turned left.

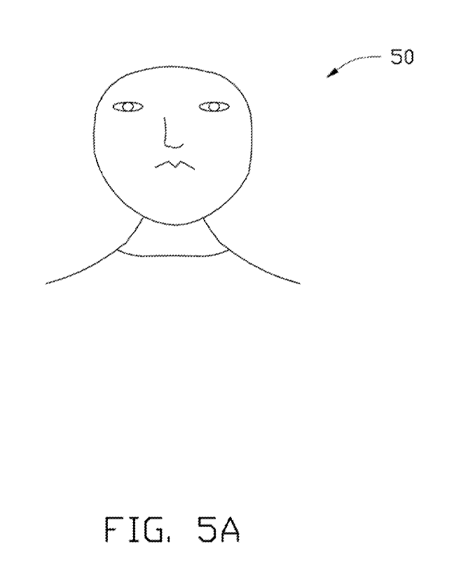

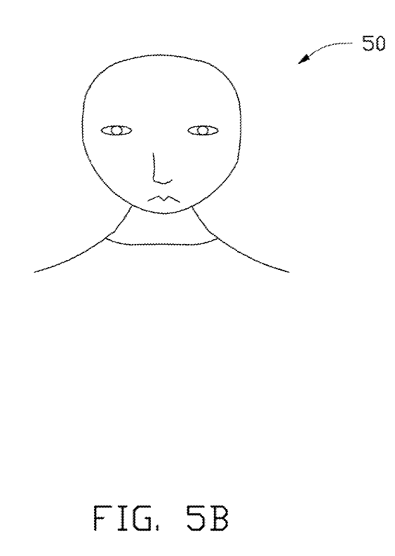

The third calculating module 230 is used to calculate the captured image to compute a raised angle or a lowered angle of the head of the subject 50. In one embodiment, the third calculating module 230 compares the reference image of FIG. 3 with the actual captured image, to compute the raised or lowered angle of the head of the subject 50. FIGS. 5A and 5B show the head is raised and lowered, respectively.

The fourth calculating module 250 is used to calculate the captured image to compute a distance between the head of the subject 50 and the second camera 30. In one embodiment, the fourth calculating module 250 compares the reference image of FIG. 3 with the actual captured image, to compute the distance between the head of the subject 50 and the second camera 30. For example, the distance between the head of the subject 50 and the second camera 30 is fifty centimeters when the size ratio of the actual captured image is the same as the size ratio of the reference image of FIG. 3.

In other embodiments, the control module 20 may further include other calculating modules to get other kinds of characteristic of the head of the subject 50, for example to calculate a number of times the subject 50 blinks their eyes on the captured image.

The control module 260 receives the calculated results of the first to fourth calculating modules 210, 220, 230, and 250, and correspondingly outputs control signals to the first camera 10 to adjust the parameters of the first camera 10. For example, when the first calculating module 210 calculates the head of the subject 50 is tilted right ten degrees, the control module 260 outputs a first control signal to control the first camera 10 to move ten degrees clockwise on the sliding rail 40 correspondingly. When the second calculating module 220 calculates the head of the subject 50 is turned left ten degrees, the control module 260 outputs a second control signal to control the lens of first camera 10 to turn left ten degrees correspondingly. When the third calculating module 230 calculates the head of the subject 50 is raised ten degrees, the control module 260 outputs a third control signal to control the lens of first camera 10 to rotate up ten degrees correspondingly. When the fourth calculating module 250 calculates the distance between the second camera 30 and the head of the subject 50 is reduced by ten centimeters, the control module 260 outputs a fourth control signal to control the focus of the first camera 10 to be shortened correspondingly.

In one embodiment, the first camera 10 includes a driving unit (not shown), the driving unit is used to adjust the parameters of the first camera 10 according to the control signals from the control module 260. In other embodiments, the camera adjusting system 100 further includes a network module (not shown), which is used to transmit the control signals from the control module 260 to the driving unit.

An example explaining the work process of the first to fourth calculating modules 210, 220, 230, and 250 is given in the next paragraph. The second to fourth calculating modules 220, 230, and 250 have a similar work process, therefore no example will be given.

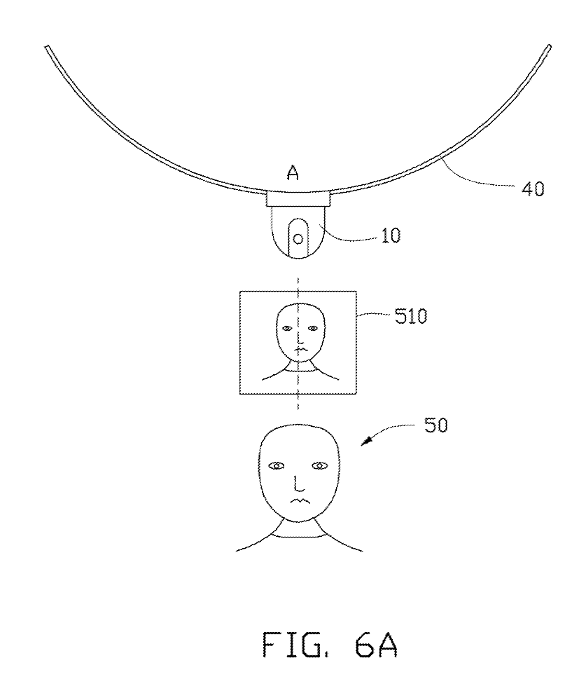

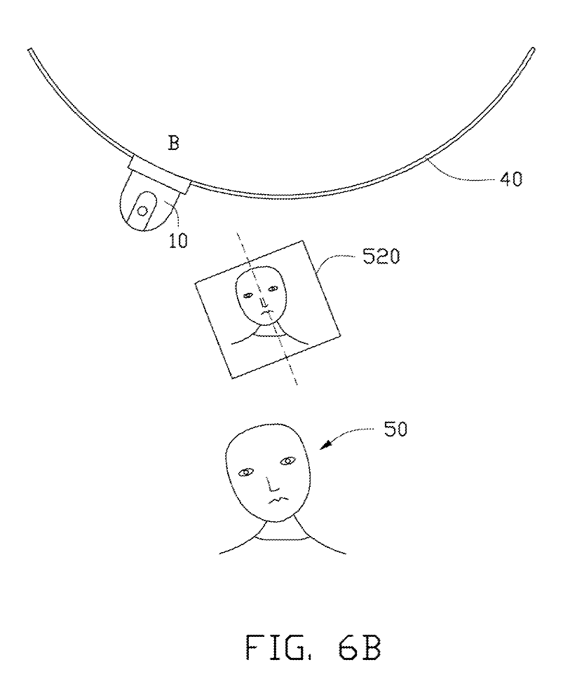

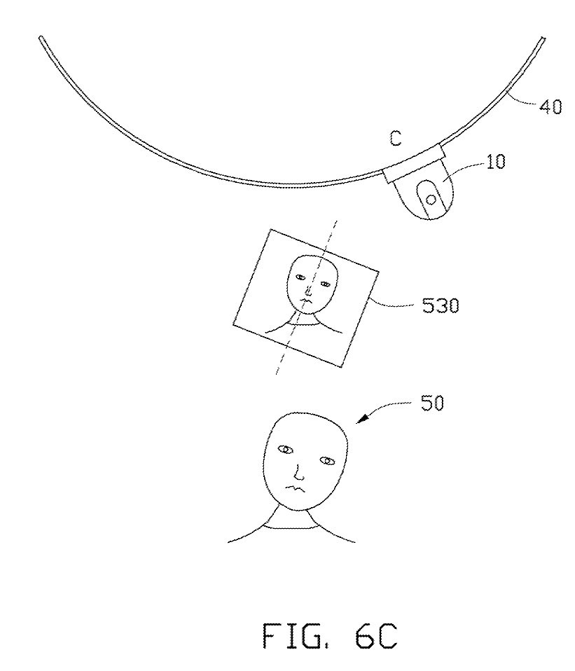

Example, referring to FIG. 6A, the head of the subject 50 directly faces the second camera 30. The second camera 30 captures an image 510 of the head of the subject 50. The control apparatus 20 receives the image 510. Because the image 510 is the same as the reference image, the first camera 10 will not be changed and is still fixed on an original position A of the sliding rail 40. Referring to FIG. 6B, the head of the subject 50 is tilted right about forty-five degrees. The second camera 30 captures an image 520. The control apparatus 20 receives the image 520. The first calculating module 210 compares the reference image with the actual captured image, to compute the corresponding tilted angle of the head of the subject 50. The control module 260 receives the calculated result and outputs the first control signal to control the first camera 10 to move forty-five degrees clockwise on the sliding rail 40 to a position B of the sliding rail 40 correspondingly. Referring to FIG. 6C, the head of the subject 50 is tilted left forty-five degrees. The second camera 30 captures an image 530. The control apparatus 20 receives the image 530. The first calculating module 210 compares the reference image with the actual captured image, to compute the corresponding tilted angle of the head of the subject 50. The control module 260 receives the calculated result and outputs the first control signal to control the first camera 10 to move forty-five degrees anticlockwise on the sliding rail 40 to a position C of the sliding rail 40 correspondingly.

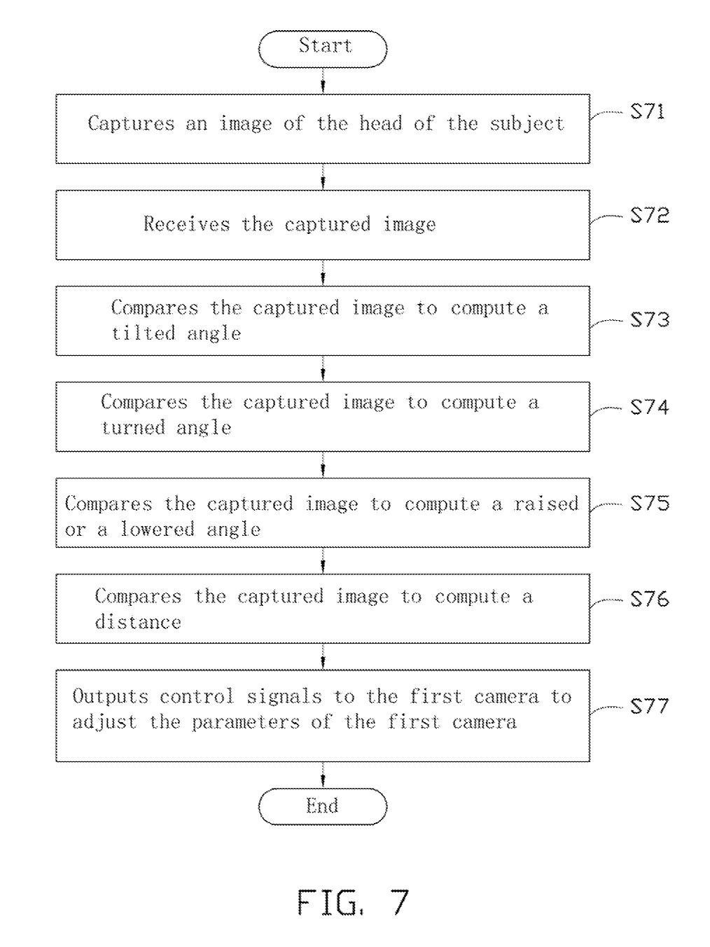

Referring to FIG. 7, an embodiment of a camera adjusting method includes the following steps.

In step 71, the second camera 30 captures an image of the head of the subject 50.

In step S72, the head detecting modules 200 receives the captured image from the second camera 30. The head detecting module 200 may use the AdaBoost algorithm to detect the captured image.

In step S73, the first calculating module 210 compares the captured image with a reference image, to compute a first result of a tilted angle of the head of the subject 50.

In step S74, the second calculating module 220 compares the captured image with the reference image, to compute a second result of a turned angle of the head of the subject 50.

In step S75, the third calculating module 230 compares the captured image with the reference image, to compute a third result of a raised or a lowered angle of the head of the subject 50.

In step S76, the fourth calculating module 250 compares the captured image with the reference image, to compute a fourth result of a distance between the head of the subject 50 and the second camera 30.

In step S77, the control module 260 receives the results of the first to fourth calculating modules 210, 220, 230, and 250, and correspondingly outputs control signals to the first camera 10 to adjust the parameters of the first camera 10.

In other embodiments, the four steps of S73, S74, S75, and S76 can be executed in any other order, such as S74 firstly, S76 secondly, S75 thirdly, and S73 lastly.

The camera adjusting method used in the camera adjusting system 100 can control the first camera 10 according to the action of the head of the subject 50, which is very easily controlled.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A camera adjusting system, comprising:
a first camera movably mounted on a sliding rail;
a second camera to capture an image of a head of a subject; and
a control apparatus to receive the captured image of the head of the subject and compare the captured image with a reference image to compute a compared result, and output a control signal to the first camera to adjust parameters of the first camera according to the compared result; wherein the parameters of the first camera comprise capturing angles, zoom scales, and positions of the first camera on the sliding rail.

2. The camera adjusting system of claim 1, wherein the control apparatus comprises a head detecting module, a calculating module, and a control module, the head detecting module receives the captured image of the head of the subject, the calculating module compares the captured image with the reference image to compute a tilted angle of the head of the subject, the control module outputs the control signal to control the first camera to correspondingly move clockwise or anticlockwise on the sliding rail according to the computed tilted angle.

3. The camera adjusting system of claim 1, wherein the control apparatus comprises a head detecting module, a calculating module, and a control module, the head detecting module receives the captured image of the head of the subject, the calculating module compares the captured image with the reference image to compute a turned angle of the head of the subject, the control module outputs the control signal to control a lens of the first camera to correspondingly rotate left and right according to the computed turned angle.

4. The camera adjusting system of claim 1, wherein the control apparatus comprises a head detecting module, a calculating module, and a control module, the head detecting module receives the captured image of the head of the subject, the calculating module compares the captured image with the reference image to compute a raised or lowered angle of the head of the subject, the control module outputs the control signal to control a lens of the first camera to correspondingly rotate up or down according to the computed raised or lowered angle.

5. The camera adjusting system of claim 1, wherein the control apparatus comprises a head detecting module, a calculating module, and a control module, the head detecting module receives the captured image of the head of the subject, the calculating module compares the captured image with the reference image to compute a distance between the second camera and the head of the subject, the control module outputs the control signal to control the first camera to correspondingly adjust the focus of first camera according to the computed distance.

6. The camera adjusting system of claim 1, wherein the sliding rail is circular.

7. A camera adjusting method to adjust parameters of a first camera according to an image of a head of a subject captured by a second camera, the first camera movably arranged on a sliding rail, the camera adjusting method comprising:
capturing an image of the head of the subject by the second camera;
receiving the captured image of the head of the subject from the second camera;
comparing the captured image with a reference image to compute a compared result; and
outputting a control signal to the first camera to adjust parameters of the first camera according to the compared result; wherein the parameters of the first camera comprise capturing angles, zoom scales, and positions of the first camera on the sliding rail.

8. The camera adjusting method of claim 7, wherein in the comparing step, comparing the captured image with the reference image computes a tilted angle of the head of the subject; and
wherein in the outputting step, the control signal controls the first camera to correspondingly move clockwise or anticlockwise on the sliding rail according to the computed tilted angle.

9. The camera adjusting method of claim 7, wherein in the comparing step, comparing the captured image with the reference image computes a turned angle of the head of the subject; and
wherein in the outputting step, the control signal controls a lens of the first camera to correspondingly rotate left or right according to the computed turned angle.

10. The camera adjusting method of claim 7, wherein in the comparing step, comparing the captured image with the reference image computes a raised or lowered angle of the head of the subject; and
wherein in the outputting step, the control signal controls the first camera to correspondingly rotate up or down according to the computed raised or lowered angle.

11. The camera adjusting method of claim 7, wherein in the comparing step, comparing the captured image with the reference image computes a distance between the second camera and the head of the subject; and
wherein in the outputting step, the control signal controls the focus of the first camera to correspondingly be shorten or lengthen according to the computed distance.
